(19) United States
(12) Patent Application Publication
(10) Pub. No.: US 2024/0402052 A1
(43) Pub. Date: Dec. 5, 2024

(54) METHOD AND SYSTEM FOR MONITORING A ROTATING EQUIPMENT

(71) Applicants: Anil Agrawal, Westford, MA (US); Prashant Kapadia, Ahmedabad (IN); Nukul Khadse, Ahmedabad (IN)

(72) Inventors: Anil Agrawal, Westford, MA (US); Prashant Kapadia, Ahmedabad (IN); Nukul Khadse, Ahmedabad (IN)

(21) Appl. No.: 18/205,579

(22) Filed: Jun. 5, 2023

(51) Int. Cl. G01M 99/00; G06N 20/00

(52) U.S. Cl. CPC G01M 99/005; G06N 20/00

(57) ABSTRACT

A system for monitoring a rotating equipment using a machine learning (ML) is provided with a server comprising a database, one or more sensors mounted on the rotating equipment, and one or more processors communicatively coupled with the server and the one or more sensors. The one or more processors is configured to receive a data of the rotating equipment from one or more sensors mounted on the rotating equipment, extract a set of spectral components from the received data, store the extracted set of spectral components as historical data within a database of a server, train a machine learning (ML) model using the historical data stored within the database of the server, run an inference using the ML model over a real-time data of the rotating equipment, and predict and flag an abnormal behaviour of the rotating equipment based on an output of the inference.

### TECHNICAL FIELD

The present invention relates to a method and system for monitoring rotating equipment using machine learning (ML) to predict and flag probability of an abnormal behavior of a rotating equipment.

### BACKGROUND

The increase in the global demand for goods because of the increase in global population and the upliftment of the quality of life of the people has caused rapid industrialization to cope up with the demand. Across industries, machines with rotating equipment as the main part i.e. engines, compressors, turbines, pumps, generators, blowers, gearboxes, etc. are playing the most critical role in the fulfillment of the demand. But, the key challenge associated with these critical machines is to keep the rotating equipment, and hence the machines, up and running. This requires continuous monitoring and health checkup of the rotating equipment, frequent visits to the machines in varying temperatures to collect readings of working of the rotating equipment, a checklist fill-out with the readings, maintenance of a stock of other critical equipment of the rotating equipment, and preparation of a maintenance calendar for the rotating equipment.

Despite all these activities, the chances of the breakdown of the rotating equipment are high, because, such activities are only preventive measures to avoid the breakdown or abnormal behavior. However, there is a lack of predictive measures to predict the possibility of abnormal behavior. Further, there is a lack of continuous remote monitoring for the prediction of abnormal behavior. This may result in a safety issue during the parameter readings, cause unplanned downtime, and even cause a shutdown of operation.

Therefore, there is a need for a method and a system for continuous and remote monitoring of the rotating equipment to predict and flag abnormal behavior.

### SUMMARY

The present disclosure discloses a method, system, and non-transitory computer-readable medium for monitoring rotating equipment to predict and flag probability of an abnormal behavior of the rotating equipment. A first aspect of the present disclosure relates to a system for monitoring rotating equipment to predict and flag the probability of the abnormal behavior of the rotating equipment. The system, according to the first aspect, is provided with a server comprising a database, one or more sensors, one or more processors, and memory. The one or more sensors are mounted on the rotating equipment to monitor the vibration and process parameters corresponding to the rotating equipment. The one or more processor are coupled with the server and the one or more sensors. The memory is coupled with the one or more processors. The memory further comprises a machine learning algorithm embodied within the memory that configures the one or more processors to receive a data of the rotating equipment from the one or more sensors mounted on the rotating equipment, extract a set of spectral components from the received data, store the extracted set of spectral components as historical data within the database of the server, train a machine learning model (ML) using the historical data stored within the database of the server, run an inference using the MI . . . model over a real-time data of the rotating equipment, and predict and flag the probability of the abnormal behavior of the rotating equipment based on an output of the inference.

The one or more processors are further configured to compute an actual data from the received data, compute a spectral data from the actual data, and extract the set of spectral components from the spectral data.

The one or more processors stores the data received from one or more sensors, the actual data computed from the received signal, and the spectral data computed from the actual data as the historical data. Further, the set of spectral components comprises computed values of vibration of the rotating equipment, computed values of harmonies of the vibration, computed values of vibration on bearing frequencies, and computed values of the vibration of any other rotating components of the rotating equipment.

The one or more processors are configured to obtain the historical data related to the rotating equipment from the database of the server, obtain a reference data from the historical data, create a first empty matrix, store the reference data within the first empty matrix to create a first matrix, remove null values, duplicate values, and outliers from the first matrix, and store the first matrix in the database of the server to train the ML model. The first matrix stores and holds the reference data of the rotating equipment as vectors. The reference data is the data associated with a normal operational state of the rotating equipment.

Further, the one or more processors is configured to perform a similarity operation on the first matrix to obtain an output product, perform a normalization of the output product to obtain a normalized product, perform a pseudo-inverse operation on the normalized product to obtain a product of pseudo-inverse operation, and store the product of pseudo-inverse operation within the database of the server.

The one or more processors are further configured to run the inference using the ML model. To run the inference using the ML model, the one or more processors are configured to receive the real-time data of the rotating equipment from the one or more sensors mounted on the rotating equipment, create a second empty matrix to hold a plurality of vectors associated with the real-time data, obtain the historical data associated with the rotating equipment stored within the database of the server, store the historical data within the second empty matrix to obtain a second matrix, perform averaging aggregation on the second matrix and storing the product as an input vector, process the input vector to obtain a residue vector as the output of the inference, and predict the probability of the abnormal behavior of the rotating equipment.

Further, the one or more processors are configured to perform a similarity operation between the input vector and the first matrix of the ML model to obtain a product of vector similarity operation, perform a matrix multiplication operation between the product of vector similarity operation and the product of the pseudo-inverse operation of the ML model to obtain a vector of weights corresponding to each vector of the second matrix, normalize the vector of weights to obtain a weighing vector, calculate a dot product between the first matrix of the ML model and the weighing vector to obtain a predicted vector, and calculate the residue vector based on the predicted vector.

Further, the one or more processors using a value of the residue vector, predicts the probability of the abnormal behavior or anomaly that may be introduced in the rotating equipment in the near future so that the user may take preventive actions to prevent the anomaly. The predicted vector is the difference in values of the input vector and the predicted vector.

In simple words, the one or more processors, using the historical data and the ML model, determine the predicted values of an output of the one or more sensors. Further, the one or more processors calculate the difference between the predicted value of the output and real-time values of the output of the one or more sensors to determine the residue values. The one or more processors predict the probability of the abnormal behavior or anomaly using the residue values.

### BRIEF DESCRIPTION OF DRAWINGS

FIG. 1 is a block diagram of a system for monitoring rotating equipment, according to an embodiment of the present disclosure;

FIG. 2 is a flowchart of a method for monitoring rotating equipment, according to an embodiment of the present disclosure;

FIG. 3 is a flowchart of a method for training a machine learning (ML) model, according to an embodiment of the present disclosure;

FIG. 4 is a flowchart of a method for running an inference using the ML, model, according to an embodiment of the present disclosure;

FIG. 5 is a block diagram of a machine learning assembly, according to an embodiment of the present disclosure.

### DETAILED DESCRIPTION

Embodiments of the present disclosure will be described below with reference to the drawings. The reference numerals are given to the same corresponding parts in the figures, and the description will not be repeated. At least some of the embodiments described below may be arbitrarily combined.

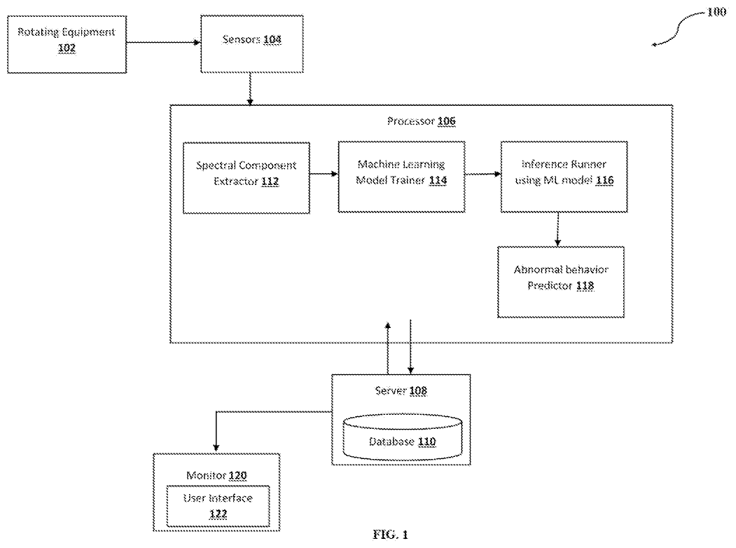

FIG. 1 is a block diagram of a system 100 for monitoring rotating equipment 102, according to an embodiment of the present disclosure.

Referring to FIG. 1, the system 100 is provided for monitoring the rotating equipment 102 using machine learning (ML) model to predict the abnormal behavior of the rotating equipment 102. Further, the system is provided to flag a user based on the predicted probability of abnormal behavior. This may allow the user to take corrective action and prevent the possible anomaly of the rotating equipment 102. The system 100 comprises one or more sensors 104, one or more processors 106, a server 108 with a database 110, and a monitor 120 having a user interface 122.

The one or more sensors 104 may be mounted over the rotating equipment 102, near or on a rotating component of the rotating equipment 102. The one or more sensors 104 may be mounted to monitor and collect data associated with the rotating equipment 102. The data comprises the vibration of the rotating component of the rotating equipment 102, harmonics of the vibration, vibration on bearing frequencies, and vibration of any other rotating component associated with the rotating equipment 102. The one or more sensors 104 may further monitor the process parameters associated with the rotating equipment 102. The process parameters may include the temperature of the rotating component of the rotating equipment 102. The one or more sensors may be a microelectromechanical system (MEMS) based sensors.

The one or more sensors 104 may be coupled with the one or more processors 106 to transmit the collected data. The processor 106 is coupled with the server 108 to store the received data from the sensors 104 over the database 110 of the server 108

It is to be noted that, hereinafter, the phrases “one or more sensors 104” and “sensors 104” may be used interchangeably. Similarly, the plural phrase “one or more processors 106” may be, interchangeably, used as a singular phrase “processor 106” hereinafter.

The processor 106 further comprises a spectral component extractor 112, a machine learning model trainer 114, an inference runner using ML model 116, and an abnormal behavior predictor 118.

The processor 106 is configured to extract a set of spectral components from the data received from the one or more sensors 104. Further, the processor 106 is configured to store the extracted set of spectral components as historical data over the database 110 of the server 108.

The processor 106 may receive the data from the sensors 104 and compute an actual data from the received data. The actual data may be the data without components of noise and gravity. Further, the processor 106 may compute a spectral data from the actual data and extract the set of the spectral components from the spectral data.

The extracted set of the spectral components includes computed values of vibration of a rotating component of the rotating equipment 102, computed values of harmonics of the vibration, computed values of the vibration on bearing frequencies, and computed values of the vibration of any other rotating components present within the rotating equipment 102. The rotating components may be a main rotating shaft or a rotor, bearing and any other rotating component configured within the rotating equipment 102.

Further, the processor 106 stores the received data from the sensors 104, the actual data computed from the received data, and the spectral data computed from the actual data over the database 110 of the server 108 as the historical data.

Further, the processor 106 is configured to train the machine learning (ML) model for the rotating equipment 102 using the historical data associated with the rotating equipment 102. The processor 106 obtains the historical data associated with the rotating equipment 102 from the database 110 of the server 108. Further, the processor 106 obtains the reference data from the historical data. The reference data is data that corresponds to the normal operational state of the rotating equipment 102. Further, the processor 106 creates a first matrix and a product of a pseudo-inverse operation by creating an empty matrix, stores the reference data as a plurality of vectors to obtain the first matrix, and processes the first matrix to obtain the product of the pseudo-inverse operation as the trained ML model.

Further, the processor 106 is configured to receive a real-time data from the sensors 104 associated with the rotating equipment 102 for which the ML model is created. The processor runs an inference over the real-time data received from the sensors 104 using the created ML model to obtain an input vector of the output of the sensors 104, determine the predicted vector of the output of the sensors 104, and calculate the residual vector. The input vector represents an actual real-time value of output data of the sensors 104. The predicted vectors represent a predicted value of output of the sensors 104. The difference between the predicted value and the real-time value of the output data of the sensors 104 represents a residual vector. Further, the residual vector represents the residual value and an output of the inference. The processor 106, using the residual vector, predicts the probability of the abnormal behavior of the rotating equipment 102.

The real-time data is received for a predefined amount of time from the sensors 104 when the rotating equipment 102 is in a working condition. For instance, the processor 106 may receive data for 15 minutes in real-time from the sensors 104 when the machine is working. Similarly, the processor 106 may receive data for 10 minutes or any other amount of time in real-time from the sensors 104 as the real-time data.

The monitor 120 is coupled with the processor 106 through the server 108. In one embodiment, the monitor 120 may be configured to flag the abnormality predicted by the processor 106 over the user interface 122. Further, the user interface 122 may be configured to display the real-time data received from the sensors 104. In another embodiment, the server 108 may be coupled with at least one user device as a user interface 122 to flag the abnormality predicted by the processor 106. The user device may include any smartphone, PC, laptop, tablet, or any other dedicated smart user device.

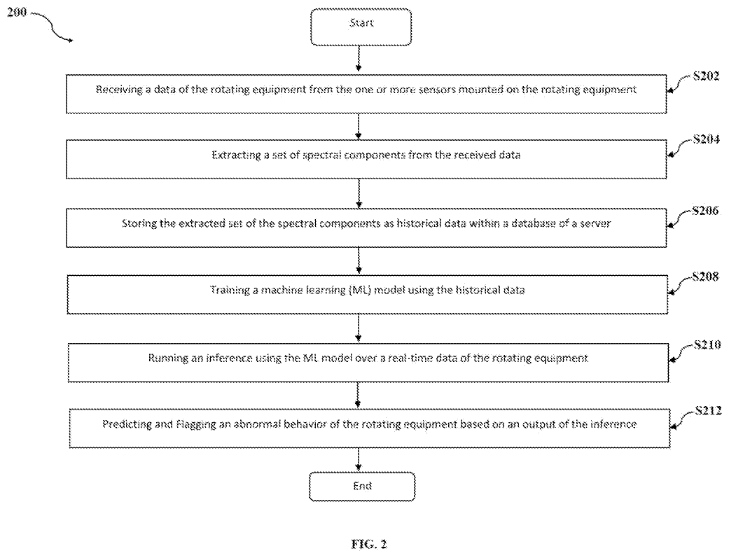

FIG. 2 is a flowchart 200 of a method for monitoring rotating equipment 102, according to an embodiment of the present disclosure.

Referring to the FIG. 2, the processor 106 receives data of the rotating equipment 102 from the sensors 104 mounted on the rotating equipment 102, as step S202. For example, the processor receives a sensory data such as a vibration of the rotating equipment 102, harmonics of the vibration, the vibration of the rotating equipment 102 on different bearing frequencies, a vibration of other rotating components of the rotating equipment 102, and other process parameters associated with the rotating equipment 102.

Further, the processor 106 extracts a set of spectral components from the data received from the sensors 104, as step S204. For example, the processor filters out the noise or gravity components from the received sensory data to compute an actual data, computes a spectral data from the actual data, and extracts the set of spectral components. The spectral components are computed values of, the vibration of the rotating equipment 102, the values of harmonics, the values of vibration on bearing frequencies, and the values of vibration of other rotating equipment 102.

Successively, the processor 106 stores the extracted spectral components as historical data over a database 110 of a server 108, as step S206. For example, the computed values of vibration, harmonics, etc. associated with the rotating equipment 102 are stored by the processor 106 as the historical data of the same rotating equipment 102 over the database 110 of the server 108.

Further, the processor 106 trains the Machine Learning (ML) model for the rotating equipment 102 using the historical data associated with the rotating equipment 102, as step S208. For example, the historical data associated with the rotating equipment 102 stored within the server 108 is used by the processor 106 to train the ML model.

Further, the processor 106 receives a real-time data from the sensors 104 and runs an inference over the real-time data using the ML model, as step S210. For example, the inference is executed over the real-time data using the trained ML model to determine the predicted value of the output of the sensors 104. Further, the inference is executed to calculate a difference between the predicted value/predicted vector and actual value/input vector of the output of the sensors 106. The difference between the predicted value and the actual value is a residual values/residual vector which is an output of the inference.

Successively, the processor 106 predicts a probability of the abnormal behavior using the output of the inference and flags the probability of the abnormal behavior, as step S212. For example, the output of the inference or the residual value is related with the probability of the abnormal behavior. The processor 106, using the calculated value of the residual vector, predicts the probability of abnormal behavior. When detecting the probability of abnormal behavior or anomaly in the rotating equipment 102 in near future, the processor 106 flags the probability over the user interface 122 for the user to take corrective actions and prevent the anomaly.

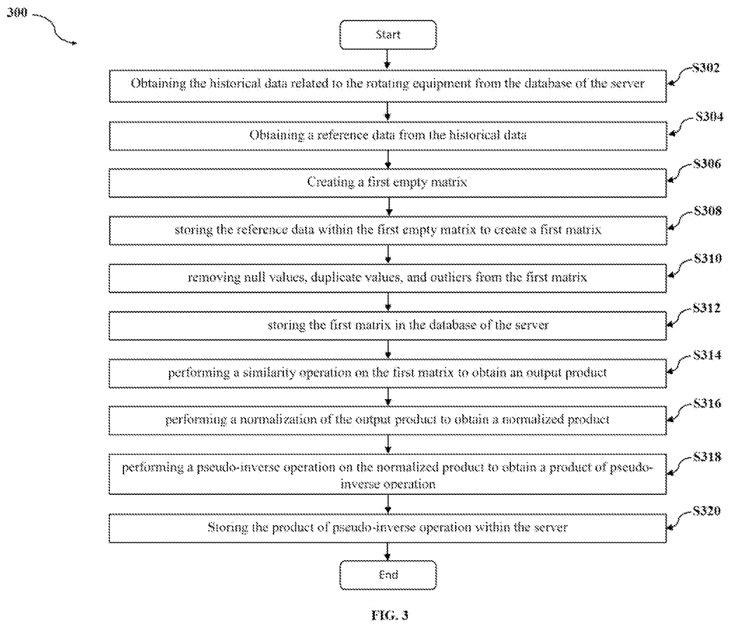

FIG. 3 is a flowchart 300 of a method for training a machine learning (ML) model, according to an embodiment of the present disclosure.

Referring to FIG. 3, the processor 106 obtains the historical data associated with the rotating equipment 102 from the server 108, as step S302. For example, the processor 102 obtains the historical data including the spectral components having values of vibration, harmonics, vibration on bearing frequencies, etc. of the rotating equipment 102 from the database 110 of the server 108.

Further, the processor 102 obtains a reference data from the obtained historical data, as step S304. For example, the processor 102 obtains a data associated with the normal operational state of the rotating equipment 102 from the historical data as the reference data.

Further, the processor 102 creates a first empty matrix to store the obtained reference data, as step S306.

Further, the processor 102 stores the reference data within the first empty matrix to create a first matrix, as step S308. For example, the processor 102 stores values of the reference data as plurality of vectors to create the first matrix D.

Further, the processor 102 removes null values, duplicate values, and outliers from the first matrix D, as step S310. For example, the processor 102 removes all the null, duplicate, and outlier values from the stored values of the reference data of the first matrix.

Further, the processor 102 stores the first matrix D in the database 110 of the server 108, as step S312.

Further, the processor 102 performs a similarity operation on the first matrix to obtain an output product, as step S314.

Further, the processor 102 performs a normalization of the output product to obtain a normalized product, as step S316.

Further, the processor 102 performs a pseudo-inverse operation on the normalized product to obtain a product of pseudo-inverse operation, as step S318. For example, the processor 102 obtains the product of pseudo-inverse operation using (D^{T}⊗D)⁺.

Successively, the processor 102 stores the product of pseudo-inverse operation with the database 110 of the server 108, as step S320. For example, the processor 102 stores the first matrix and the product of pseudo-inverse operation in a serialized form.

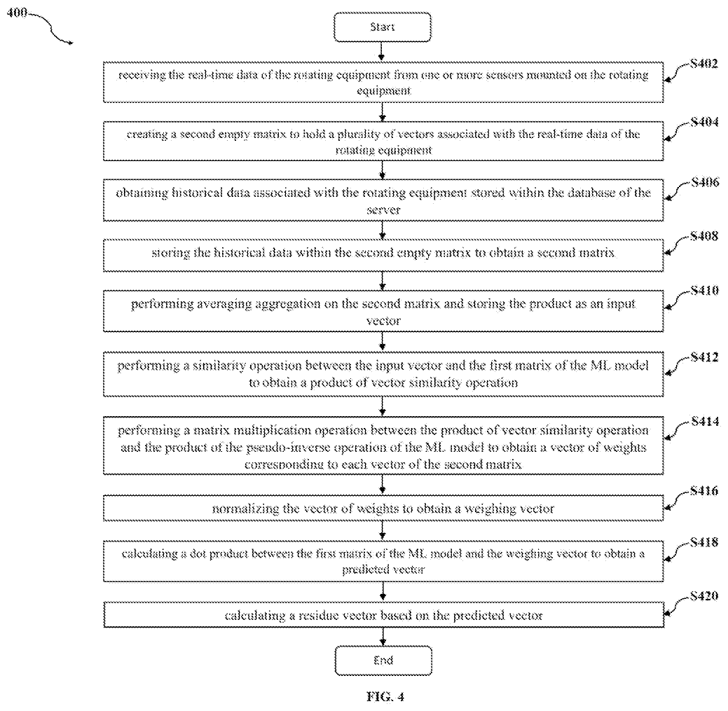

FIG. 4 is a flowchart 400 of a method for running an inference using the ML model, according to an embodiment of the present disclosure,

Referring to FIG. 4, for running the inference over the real-time data received from the sensors 104, the processor 106 first receives the real-time data of the rotating equipment 102 from the sensors 104 mounted over the rotating equipment 102, as step S402. For example, the processor 106 receives the data for specific predefined amount of time from the sensor 104 while the rotating equipment 106 is in a working condition. For instance, the processor 106 may receive the data for 15 minutes in real-time as the real-time data.

Further, the processor 106 creates a secondary empty matrix to hold the real-time data received from the sensors 104, as step S404. For example, the processor 106 creates plurality of vectors of the data received as the real-time data and stores it within the second empty matrix.

Further, the processor 106 obtains the historical data associated with the same rotating equipment 102 from the database 110 of the server 108, as step S406. For example, the processor 106 fetches the database 110 to obtain the historical data using which the ML, model for the rotating equipment 102 is trained.

Successively, the processor 106 stores the obtained historical data within the second empty matrix to obtain a second matrix, as step S408.

Further, an averaging aggregation on the second matrix is performed by the processor 106 and the product is stored as an input vector, as step S410.

Further, similarity operation between the input vector and the first matrix of the ML model which is obtained at the step S308 is performed by the processor 106 to obtain a product of vector similarity operation, as step S412.

Further, the processor 106 performs a matrix multiplication operation between the product of vector similarity operation and the product of the pseudo-inverse operation of the ML model which is obtained at the step S318 by the processor 106 to obtain a vector of weights corresponding to the each vector of the second matrix, as step S414.

Further, the processor 106 normalizes the vector of weights to obtain a weighing vector, as step S416.

Successively, the processor 106 calculates a dot product between the first matrix of the ML model and the weighing vector to obtain a predicted vector, as step S418. The predicted vector refers to the predicted values of the output of the sensors 104 by the inference.

Further, the processor 106 calculates a residue vector based on the predicted vector, as step S420. For example, the residue vector is the difference between the predicted vector and the input vector.

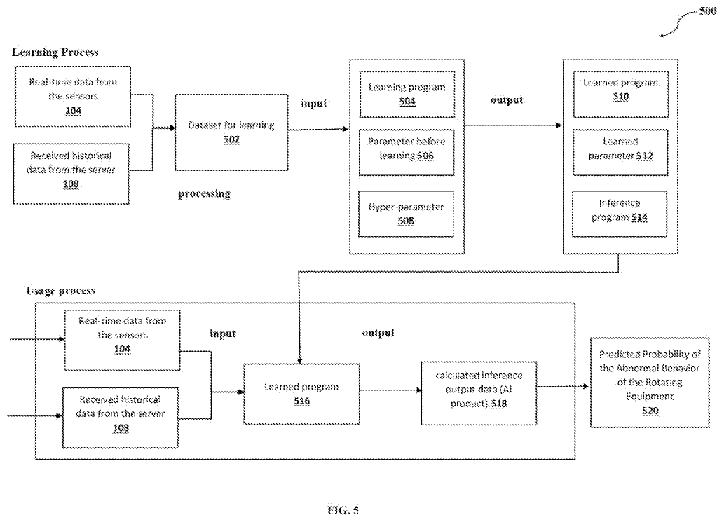

FIG. 5 is a block diagram 500 of a machine learning assembly, according to an embodiment of the present disclosure.

The machine learning assembly 500 may be configured to train a ML model for readiness output data by using actual values of the input data as training data and configured to input the input data to the ML model by the machine learning assembly 500 as a reference.

The residual value between the input values and predicted values are calculate based at least on the received real-time data from the sensors 104 and the historical data obtained from the database 110 and output the predicted probability of the abnormal behavior of the rotating equipment 102. The machine learning assembly 500 may comprise a learning process. The learning process comprises the sensors 104 mounted on the rotating equipment 102 to input the real-time data from the rotating equipment 102, and the server 108 configured to input the historical data associated with the rotating equipment 102. The real-time data and the historical data may transmit to a dataset 502 for learning.

Further, the dataset for learning 502 may be communicably coupled to a learning program 504 for the transmission of input data. The learning program 504 provides a trainer/assessor with information about the competencies and suggestions for an assessment strategy. The learning program 504 may be supervised or unsupervised. The learning program 504 is configured to process the output data to a parameter before learning 506. The parameter before learning 506 is a configuration variable internal to a model and whose value may be estimated from data received from the learning program 504. The parameter before learning 506 is configured to transmit the output data to a hyper-parameter 508. The hyper-parameter 508 is configured to process parameters to the model for the value that may not be estimated from data and send an output to a learned program 510 of learning process.

The learned program 510 may be supervised or unsupervised. Further, the learned program 510 is configured to transmit the output data to a learned parameter 512. The learned parameter 512 provides the trained information about the competencies and suggestions for the assessment strategy. The learned parameter 512 is a configuration variable internal to the model and whose value may be estimated from data received from the learned program 510. The learned parameter 512 is configured to transmit live data points into an interference program 514 to calculate the learned output data.

Further, the machine learning assembly 500 comprises a usage process. The usage process comprises the sensors 104 mounted on the rotating equipment 102 and configured to input the real-time data from the rotating equipment 102, and the server 108 configured to input the historical data associated with the rotating equipment 102. The real-time data and the historical data may transmit to a learned program 516 of the usage process. The learned program 516 of the usage process is configured to determine calculated inference output data or the residual data as an output 518. Thus, the machine learning assembly 500 is configured to predict the probability of the abnormal behavior of the rotating equipment 514.

The above embodiments are exemplary in all respect and are not restrictive. The scope of the invention is set forth in the claims, not in the above description, and includes the meaning of and all variations within the scope of the claims.

### Terminology

It is to be understood that not necessarily all objects or advantages may be achieved in accordance with any particular embodiment described herein. Thus, for example, those skilled in the art will recognize that certain embodiments may be configured to operate in a matter that achieves or optimizes one advantage or group of advantages as taught herein without necessarily achieving other objects or advantages as may be taught or suggested herein.

All of the processes described herein may be embodiment in, and fully automated via, software code module executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiments, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, a combination of the same, or the like. A processor can include electrical circuitry configured to process computer-executable instructions. In another embodiment, a processor includes an application-specific integrated circuit (ASIC), a field programmable gate array (FPGA,) or another programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computed system, including, but not limited to, a computer system based on a microprocessor, a mainframe computer, a digital signal processor, a portable computing device, a device controller, or a computational engine within an appliance, to name a few.

Conditional language such as, among others, “can”, “could”, “might” or “may”, unless specifically stated otherwise, are otherwise understood within the context as used in general to convey those certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without user input or prompting, whether these features, elements and/or steps are included or are to be performed in any embodiment.

Disjunctive language such as the phrase “at least one of X, Y. or Z.” unless specifically states otherwise, is otherwise understood with the context as used in general to present that an item, term, etc., may be either X, Y, or Z, or any combination thereof (e.g., C. Y, and/or Z). Thus, such disjunctive language is not generally intended to, and should not, imply that certain embodiments require at least one of X, at least one of Y, or at least one of Z to each be present.

Any process description, elements, or blocks in the flow diagram described herein and/or depicted in the attached figures should be understood as potentially representing modules, segments, or portions of code that include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example. “a processor configured to carry out recitations A. B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least.” the term “includes” should be interpreted as “includes but is not limited to.” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above.” “below.” “bottom,” “top,” “side.” “higher,” “lower,” “upper,” “over.” and “under,” are defined with respect to the horizontal plane.

As used herein, the terms “attached.” “connected.” “mated.” and other such relational terms should be construed, unless otherwise noted, to include removable, movable, fixed, adjustable, and/or releasable connections or attachments. The connections/attachments can include direct connections and/or connections having an intermediate structure between the two components discussed.

Unless otherwise explicitly stated, numbers preceded by a term such as “approximately”, “about”, and “substantially” as used herein include the recited numbers and also represent an amount close to the stated amount that still performs a desired function or achieves a desired result. For example, unless otherwise explicitly stated, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A method of monitoring rotating equipment using machine learning (ML), comprising:
receiving, by one or more processors, a data of the rotating equipment from one or more sensors mounted on the rotating equipment;
extracting, by the one or more processors, a set of spectral components from the received data;
storing, by the one or more processors, the extracted set of spectral components as historical data within a database of a server;
training, by the one or more processors, a machine learning (ML) model using the historical data stored within the database of the server;
running, by the one or more processors, an inference using the machine learning (ML) model over a real-time data of the rotating equipment; and
predicting and flagging, by the one or more processors, probability of an abnormal behaviour of the rotating equipment based on an output of the inference.

2. The method of claim 1, wherein the step of extracting the set of spectral components comprises:
computing an actual data from the received data;
computing a spectral data from the actual data; and
extracting the set of spectral components from the spectral data.

3. The method of claim 2, wherein the one or more processors further stores the data of the rotating equipment received from the one or more sensors, the actual data computed from the received data, and the spectral data computed from the actual data as the historical data.

4. The method of claim 2, wherein the set of spectral components comprises computed values of vibration of a rotating component of the rotating equipment, computed values of harmonies of the vibration, computed values of the vibration on bearing frequencies, and computed values of the vibration of any other rotating components of the rotating equipment.

5. The method of claim 1, wherein the step of training the ML model further comprises steps of:
obtaining the historical data related to the rotating equipment from the database of the server;
obtaining a reference data from the historical data;
creating a first empty matrix;
storing the reference data within the first empty matrix to create a first matrix;
removing null values, duplicate values, and outliers from the first matrix; and
storing the first matrix in the database of the server.

6. The method of claim 5, wherein the first empty matrix is created to store and hold the reference data of the rotating equipment as a plurality of vectors.

7. The method of claim 6, wherein the reference data corresponds to data associated with a normal operational state of the rotating equipment.

8. The method of claim 5, wherein the step of training the ML model further comprises steps of:
performing a similarity operation on the first matrix to obtain an output product;
performing a normalization of the output product to obtain a normalized product;
performing a pseudo-inverse operation on the normalized product to obtain a product of pseudo-inverse operation; and
storing the product of pseudo-inverse operation within the database of the server.

9. The method of claim 8, wherein the first matrix and the product of pseudo-inverse operation are stored in a serialized form.

10. The method of claim 1, wherein the step of running the inference using the ML model further comprises steps of,
receiving the real-time data of the rotating equipment from the one or more sensors mounted on the rotating equipment;
creating a second empty matrix to hold a plurality of vectors associated with the real-time data;
obtaining the historical data associated with the rotating equipment stored within the database of the server;
storing the historical data within the second empty matrix to obtain a second matrix;
performing averaging aggregation on the second matrix and storing the product as an input vector; and
processing the input vector to determine a residue vector as the output of the inference; and
predicting the probability of the abnormal behavior of the rotating equipment using the residue vector.

11. The method of claim 10, wherein the input vector is processed with the developed ML model to obtain the residue vector in the step of processing.

12. The method of claim 11, where the step of processing further comprises,
performing a similarity operation between the input vector and the first matrix of the ML, model to obtain a product of vector similarity operation;
performing a matrix multiplication operation between the product of vector similarity operation and the product of the pseudo-inverse operation of the ML model to obtain a vector of weights corresponding to each vector of the second matrix;
normalizing the vector of weights to obtain a weighing vector;
calculating a dot product between the first matrix of the ML model and the weighing vector to obtain a predicted vector; and
calculating the residue vector based on the predicted vector.

13. The method of claim 13, wherein the residue vector is a difference between the input vector and the predicted vector.

14. The method of claim 10, wherein the real-time data is a sensory data received for a predefined amount of time in real-time from the one or more sensors for which the rotating equipment is in a working condition.

15. A system for monitoring a rotating equipment using a machine learning (ML), comprising:
a server comprising a database;
one or more sensors mounted on the rotating equipment;
one or more processors communicatively coupled with the server and the one or more sensors; and
memory coupled to the one or more processors and comprising a machine learning algorithm embodied in the memory that configures the one or more processors to:
receive a data of the rotating equipment from one or more sensors mounted on the rotating equipment;
extract a set of spectral components from the received data;
store the extracted set of spectral components as historical data within a database of a server;
train a machine learning (ML) model using the historical data stored within the database of the server;
run an inference using the ML model over a real-time data of the rotating equipment;
predict and flag probability of an abnormal behaviour of the rotating equipment based on an output of the inference.

16. The system of claim 15, wherein the one or more sensors is configured to monitor vibration and process parameters corresponding to the rotating equipment.

17. The system of claim 15, wherein the one or more sensors is a microelectromechanical system (MEMS) based sensors.

18. The system of claim 15, further comprises a user interface communicatively coupled with the one or more processors to display the real-time data received from the sensor and flag the predicted abnormal behavior of the rotating equipment.

19. The system of claim 15, wherein
the one or more processors are further configured to
receive the real-time data from the one or more sensors mounted on the rotating equipment, receive the historical data from the server, and predict the probability of the abnormal behavior of the rotating equipment having
an ML model having the real-time data and the historical data as an input data, and an output of the inference as an inference output data;
a machine learning assembly configured to train the ML model for the inference output data by using actual values of the input data as a training data, and
configured to:
enter the real-time data to the ML model learned by the machine learning assembly as a reference;
run an inference over the real-time data of the rotating equipment to determine the input vector and the predicted vector;
calculate the residue vector as the inference output data from the input vector and the predicted vector; and
predict the probability of the abnormal behavior of the rotating equipment from the residue vector.

20. A computer program product, comprising:
a non-transitory computer-readable storage medium comprising a machine learning algorithm embodied in the medium that is executable by one or more processors to perform:
receiving a data of the rotating equipment from one or more sensors mounted on the rotating equipment;
extracting a set of spectral components from the received data;
storing the extracted set of spectral components as historical data within a database of a server;
training a machine learning (ML) model using the historical data stored within the database of the server;
running an inference using the machine learning (ML) model over a real-time data of the rotating equipment;
predicting and flagging probability of an abnormal behaviour of the rotating equipment based on an output of the inference.
